(19) United States
(12) Patent Application Publication
(10) Pub. No.: US 2009/0002787 A1
(43) Pub. Date: Jan. 1, 2009

(54) Holographic Display Devices

(76) Inventors: Adrian Cable, Hertfordshire (GB); Edward Buckley, Cambridgeshire (GB)

Correspondence Address: KNOBBE MARTENS OLSON & BEAR LLP, 2040 MAIN STREET, FOURTEENTH FLOOR, IRVINE, CA, 92614, US

(21) Appl. No.: 11/917,496

(22) PCT Filed: Jun. 15, 2006
(86) PCT No.: PCT/GB2006/050158

§ 371 Date: Aug. 7, 2008

(30) Foreign Application Priority Data
Jun. 15, 2005 (GB) 0512179.3

(51) Int. Cl. G03H 1/08

(52) U.S. Cl. 359/9

(57) ABSTRACT

This invention relates to electronic devices incorporating a holographic projector. A holographic projection module for a consumer electronic device, the holographic projection module comprising: at least one substantially monochromatic light source (12); a spatial light modulator (24) (SLM) to phase modulate light (22) from said light source to provide a phase hologram for generating a two-dimensional displayed image (14); projection optics to project said phase modulated light to form said two-dimensional displayed image; wherein said projection optics comprise an optical system (26) configured to demagnify a conventional, non-holographic image, to increase the divergence of said light forming said displayed image, —and a digital signal processor (100) to generate data for a plurality of temporal holographic sub frames from a desired image for display, for modulating said SLM, such that temporal averaging amongst the subframes reduces the perceived level of noise, in said displayed image when images corresponding to the subframes are displayed successively and sufficiently fast that they are integrated together in the eye of a human observer.

### FIELD OF THE INVENTION

This invention relates to holographic image projection systems and to electronic devices incorporating a holographic projector.

### BACKGROUND TO THE INVENTION

Many small, portable consumer electronic devices incorporate a graphical image display, generally a LCD (Liquid Crystal Display) screen. These include digital cameras, mobile phones, personal digital assistants/organisers, portable music devices such as the iPOD (trade mark), portable video devices, laptop computers and the like. In many cases it would be advantageous to be able to provide a larger and/or projected image but to date this has not been possible, primarily because of the size of the optical system needed for such a display.

Background prior art can be found in GB 2,379,351A, GB 2,350,963A, WO 00/40018, WO 2004/066037, U.S. Pat. No. 5,589,955, and U.S. Pat. No. 5,798,864. GB '351 describes a system for producing a three-dimensional image, in which the quantity of data to be displayed is reduced by using a horizontal parallax only (HPO) hologram. GB '963 describes a system in which a battle/shutter arrangement is employed, aligned with a tiled region of an SLM (Spatial Light Modulator) projection surface so that spatially tiled sub-hologram images may be employed in order to produce a three-dimensional image without the need for an optically addressed SLM. By contrast WO '018 employs an optically addressed SLM. In most of the described embodiments a conventional image is formed on an electrically addressed SLM which drives the OASLM although the possibility of using the system to display three-dimensional holographic images is mentioned. WO'037 displays computer generated hologram (CGH) images on an SLM to form a two-dimensional image at a screen, using pre-calculated CGH elements they call “hogels”, each of which is a diffraction pattern that generates a single pixel on the projection screen. However the optics to direct light diffracted by the SLM to the screen are cumbersome. U.S. Pat. No. '955 describes a laser pattern scribing device; U.S. Pat. No. '864 describes a projection-type image display apparatus in which, to avoid time consuming calculation operations, a hologram for display on a display element is calculated by supposing that a phase conjugate minor is situated at the position of the display element, summing spherical light waves, at this position, emanating from all points on a screen on which an image is to be reproduced; a complex conjugate of a result of this calculation is obtained.

### SUMMARY OF THE INVENTION

According to a first aspect of the present invention there is therefore provided a holographic projection module for a consumer electronic device, the holographic projection module comprising: at least one substantially monochromatic light source; a spatial light modulator (SLM) to phase modulate light from said light source to provide a phase hologram for generating a two-dimensional displayed image; projection optics to project said phase modulated light to form said two-dimensional displayed image; wherein said projection optics comprise an optical system configured to demagnify a conventional, non-holographic image, to increase the divergence of said light forming said displayed image; and a digital signal processor to generate data for a plurality of temporal holographic subframes from a desired image for display, for modulating said SLM, such that temporal averaging amongst the subframes reduces the perceived level of noise, in said displayed image when images corresponding to the subframes are displayed successively and sufficiently fast that they are integrated together in the eye of a human observer.

The monochromatic light source preferably comprises a laser such as a laser diode or another at least partially coherent light source, and may incorporate some form of collimation; alternatively a collimator may be included to approximately collimate the light prior to modulation by the spatial light modulator.

Counter-intuitively embodiments of the optical system produce a demagnifying effect with a conventional, non-holographic image. Substantially any sort of conventionally demagnifying optics can be employed (and if the collimation is poor then generally the optical system may be used to at least partially compensate for this). A consequence is that in embodiments of the optical system the displayed image is substantially focus-free: that is the image is substantially in focus over a wide range or at substantially all distances from the projection module.

A wide range of different optical arrangements can be used to achieve this effect but one particularly advantageous combination comprises first and second lenses with respective first and second focal lengths, the second focal length being shorter than the first and the first lens being closer to the spatial light modulator (along the optical path) than the second lens. Preferably the distance between the lenses is substantially equal to the sum of their focal distances, in effect forming a (demagnifying) telescope. In embodiments two positive (i.e., converging) simple lenses are employed although in other embodiments one or more negative or diverging lenses may be employed.

In embodiments, in particular where the incident light on the SLM is substantially collimated, the first lens may be spaced away from the SLM by a distance substantially equal to a focal length of this lens. However this is not essential and in other embodiments the first lens may be spaced away from the SLM by a distance different to a focal length of this lens, in particular where the incident light on the SLM is not collimated.

The optical system may further comprise a filter to filter out unwanted parts of the displayed image, for example a bright (zero order) undiffracted spot or a repeated first order image (which may appear as an upside down version of the displayed image).

In general any type of pixellated microdisplay which is able to phase modulate light may be employed for the SLM, optionally in association with an appropriate driver chip if needed. Embodiments use an electrically addressable SLM. Suitable SLMs include, but are not limited to, liquid crystal SLMs including LCOS (liquid crystal on silicon) and DLP (registered TM) (digital light processing) SLMs.

In embodiments the displayed image is formed from a plurality of holographic sub-images which visually combine to give (to a human observer) the impression of the desired image for display. These holographic temporal sub-frames are displayed in rapid succession so as to be integrated within the human eye. Each of the holographic temporal sub-frames generates an image having substantially a spatial extent of the desired image for display. In embodiments a holographic sub-frame substantially completely occupies the SLM (apart from 10%, 5% or fewer pixels around the edge of the SLM, to inhibit edge effects).

The data for successive holographic sub-frames may be generated by a digital signal processor, which may comprise either a general purpose DSP under software control, for example in association with a program stored in non-volatile memory, or dedicated hardware, or a combination of the two such as software with dedicated hardware acceleration. Preferred embodiments of a hardware accelerator comprise modules to implement one or more of a phase modulation stage, a space-frequency transformation stage and a quantitation stage of processing.

Thus according to a related aspect of the invention there is therefore provided a holographic projection module comprising: at least one substantially monochromatic light source; a spatial light modulator (SLM) to phase modulate light from said light source to provide a phase hologram for generating a displayed image; and a digital signal processor configured to input digital data for said displayed image and to calculate hologram data for driving said SLM to provide said phase hologram for generating said displayed image; and wherein said digital signal processor is configured to generate holographic data for a plurality of temporal sub-frames each approximating a hologram of an entire image to be displayed for driving said SLM to generate a plurality of phase hologram sub-frames such that, to a human observer, said temporal sub-frames give the impression of said displayed image, a noise variance of said displayed image being perceived as attenuated by averaging across said plurality of phase hologram subframes.

In a holographic projection module, in particular as described above, the SLM may comprise a reflective SLM. This enables a particularly compact optical design.

Thus in a further related aspect of the invention there is therefore provided a holographic projection module comprising: at least one substantially monochromatic light source; a spatial light modulator (SLM) to phase modulate light from said light source to provide a phase hologram for generating a two-dimensional displayed image; and projection optics to project said phase modulated light to form said two-dimensional displayed image; and wherein said SLM comprises a reflective SLM.

In this way, in some preferred embodiments at least part of the optical path to and from the SLM may be shared. In particular at least a portion of the projection optics may be shared, for example the demagnification system at least in part doubling as an optical collimation system. Preferably a polariser is included to suppress interference between light travelling in different directions, that is into and out of the SLM; this may conveniently (and compactly) be implemented using a polarising beam splitter. In particular a polarising beam splitter can be used to direct the output, modulated light at 90 degrees on the image plane, and also to provide the function of the polariser.

The invention further provides a consumer electronic device, in particular a portable device, including a holographic projection module along the lines described above.

The invention still further provides an advertising/signage system and a helmet-mounted or head-up display including a holographic projection module along the lines described above.

The above described aspects of the invention, and features of the above described aspects may be combined in any permutation.

These and other aspects of the invention will now be further described, by way of example only, with reference to the accompanying figures in which:

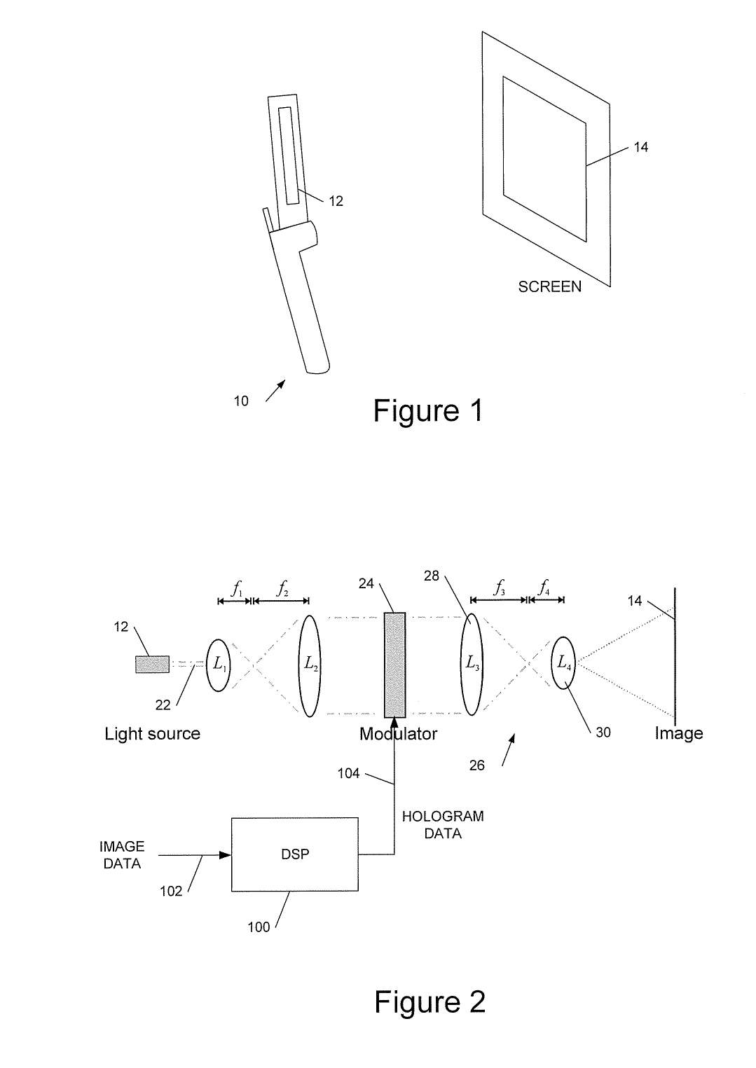

FIG. 1 shows an example of a consumer electronic device incorporating a holographic projection module;

FIG. 2 shows an example of an optical system for the holographic projection module of FIG. 1;

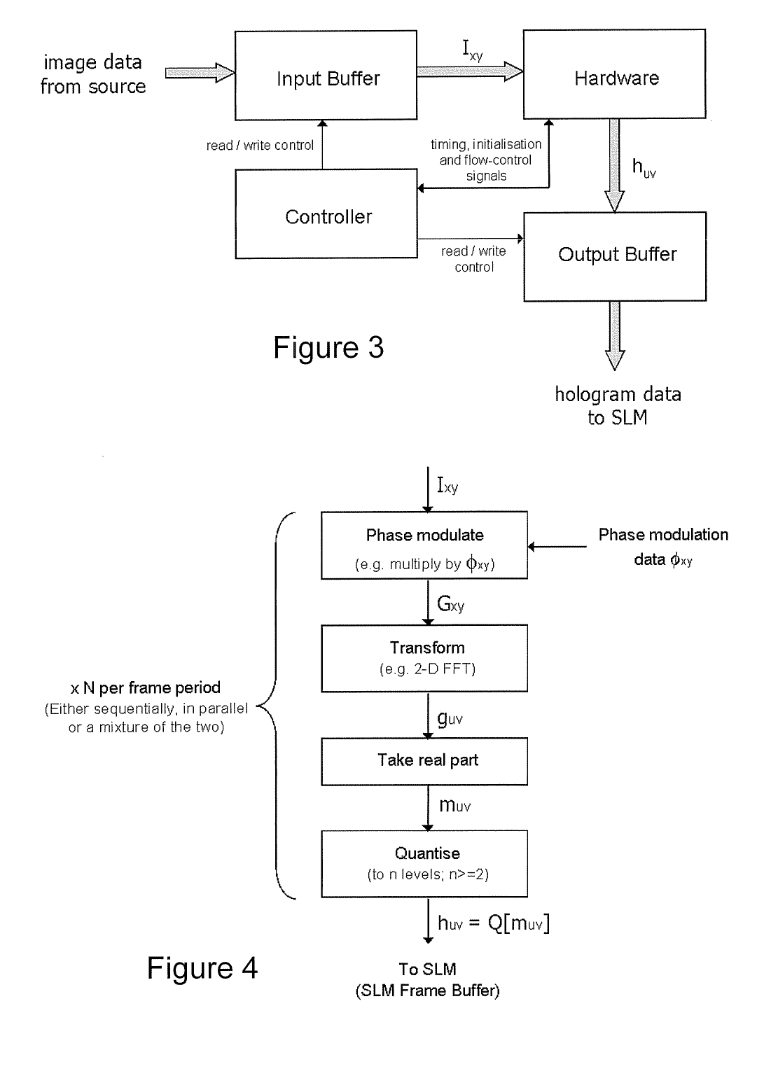

FIG. 3 shows a block diagram of an embodiment of a hardware accelerator for the holographic image display system of FIGS. 1 and 2;

FIG. 4 shows the operations performed within an embodiment of a hardware block as shown in FIG. 3;

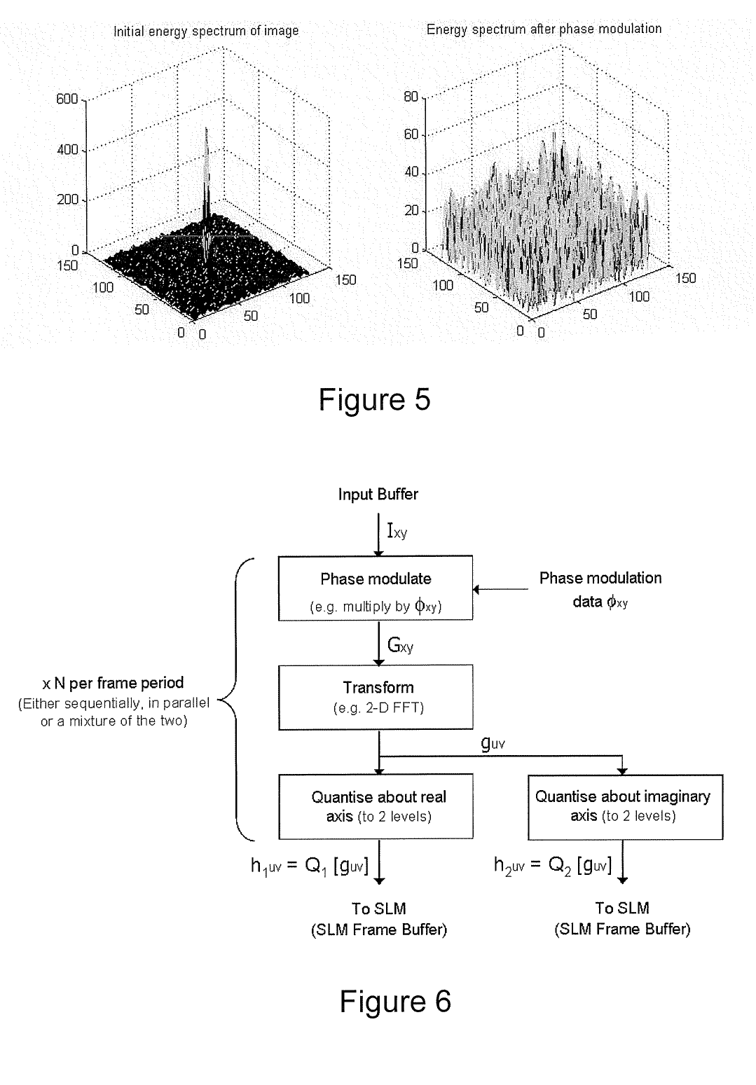

FIG. 5 shows the energy spectra of a sample image before and after multiplication by a random phase matrix;

FIG. 6 shows an embodiment of a hardware block with parallel quantisers for the simultaneous generation of two sub-frames from the real and imaginary components of the complex holographic sub-frame data respectively;

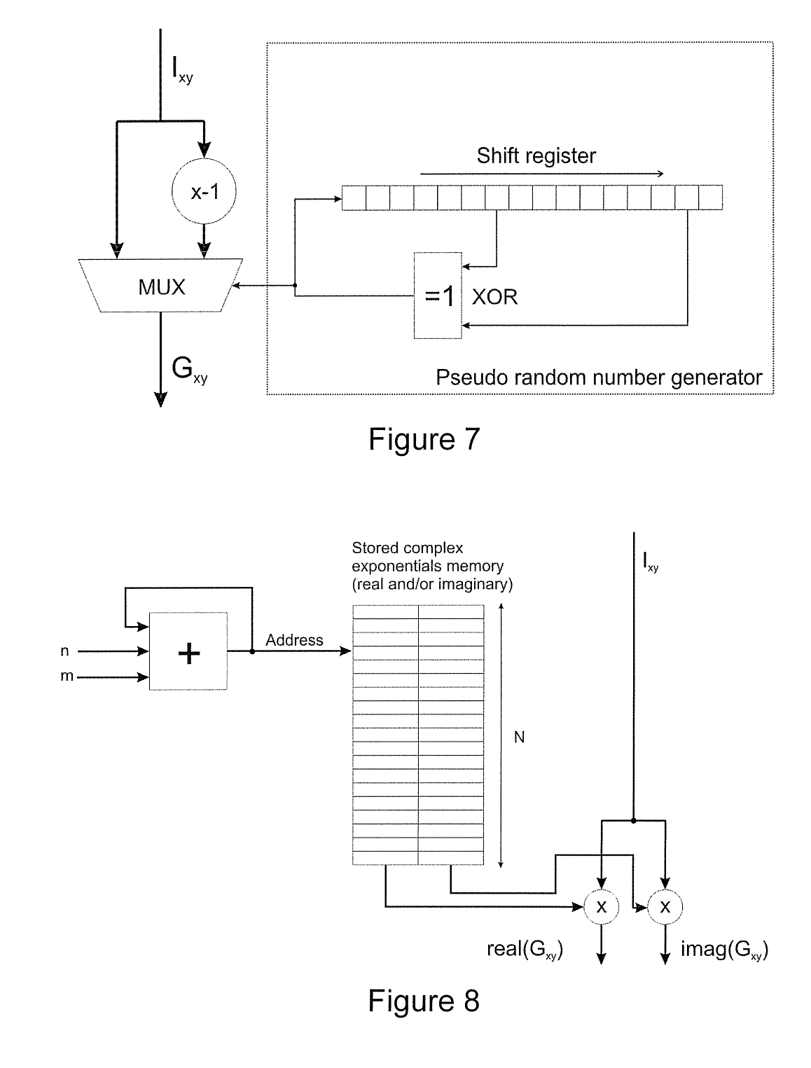

FIG. 7 shows an embodiment of hardware to generate pseudo-random binary phase data and multiply incoming image data, I_{xy}, by the phase values to produce G_{xy};

FIG. 8 shows an embodiment of hardware to multiply incoming image frame data, I_{xy}, by complex phase values, which are randomly selected from a look-up table, to produce phase-modulated image data, G_{xy};

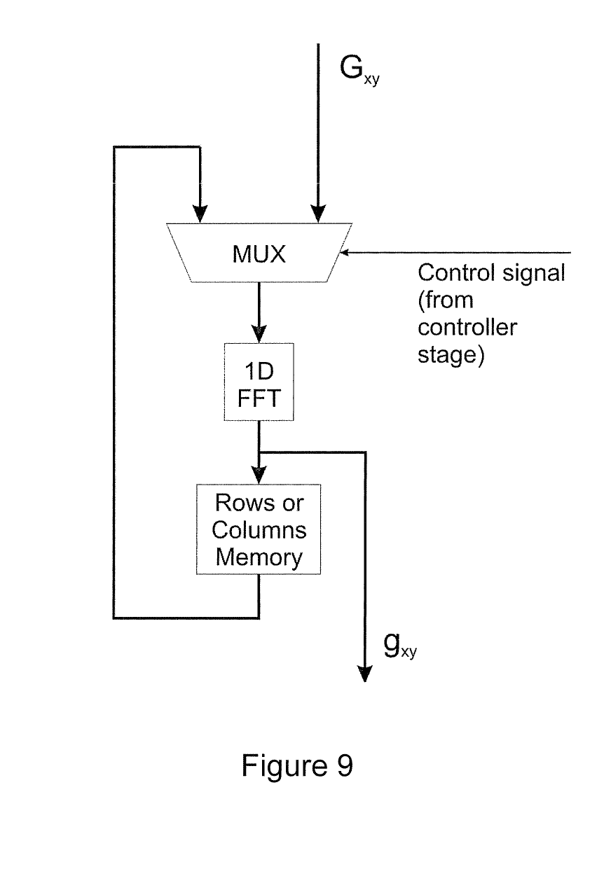

FIG. 9 shows an embodiment of hardware which performs a 2-D FFT on incoming phase-modulated image data, G_{xy} by means of a 1-D FFT block with feedback, to produce holographic data gᵤᵥ;

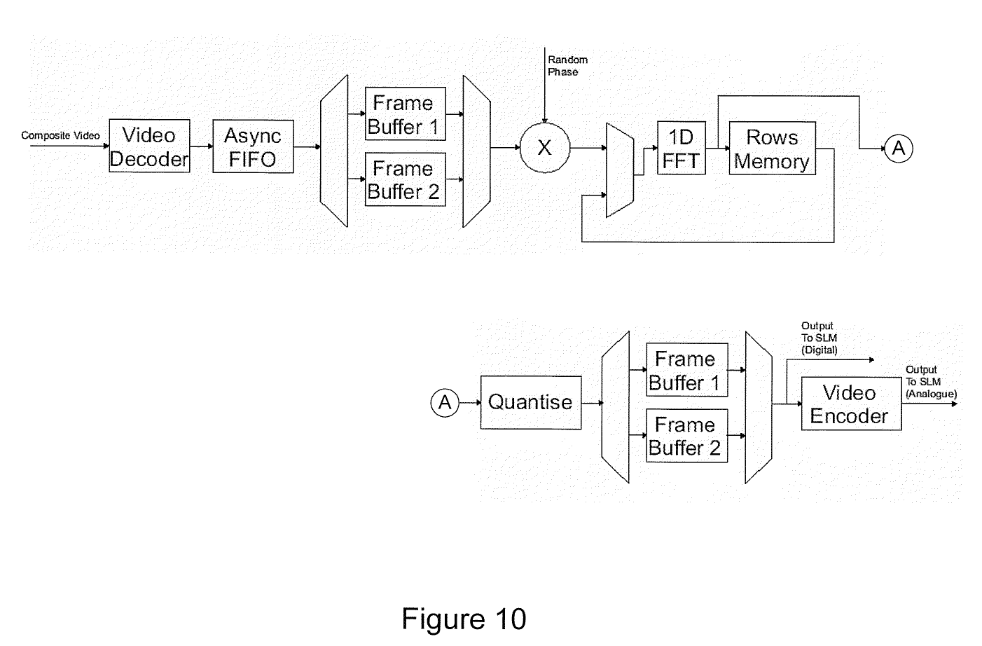

FIG. 10 shows a block diagram of further example hardware for a holographic image display system; and

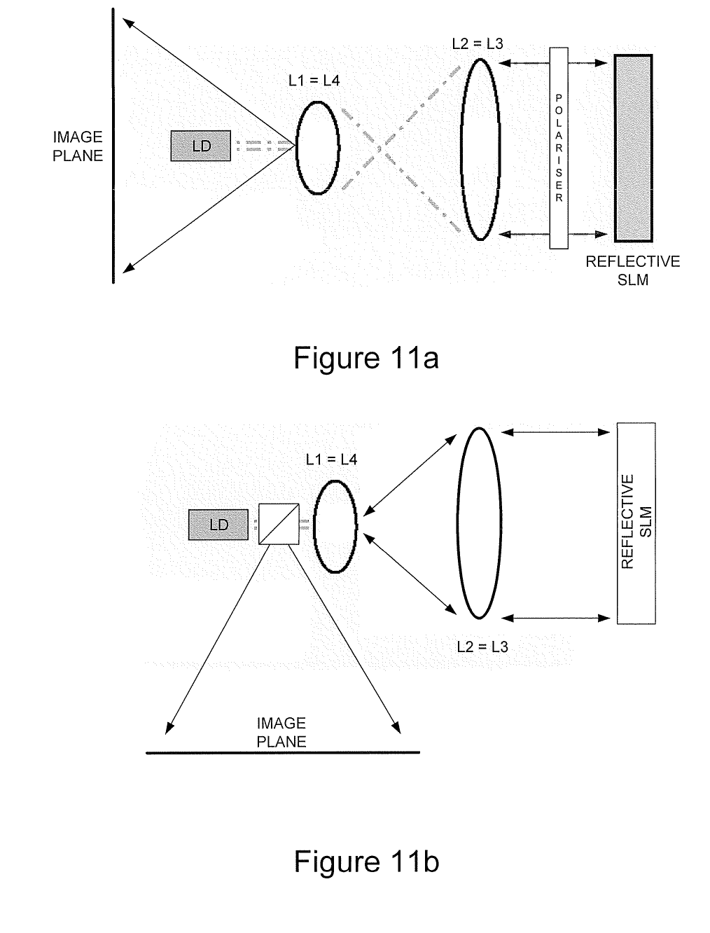

FIGS. 11a and 11b show further examples of optical systems for the holographic projection module of FIG. 1, illustrating lens sharing arrangements.

We have previously described, in UK Patent Application No. GB0329012.9, filed 15 Dec. 2003 now published as WO2005/059881 (hereby incorporated by reference in its entirety), a method of displaying a holographically generated video image comprising plural video frames, the method comprising providing for each frame period a respective sequential plurality of holograms and displaying the holograms of the plural video frames for viewing the replay field thereof, whereby the noise variance of each frame is perceived as attenuated by averaging across the plurality of holograms. The video image may be a moving picture or still image.

Broadly speaking embodiments of the method aim to display an image by projecting light via a spatial light modulator (SLM) onto a screen. The SLM is modulated with holographic data approximating a hologram of the image to be displayed but this holographic data is chosen in a special way, the displayed image being made up of a plurality of temporal sub-frames, each generated by modulating the SLM with a respective sub-frame hologram. These sub-frames are displayed successively and sufficiently fast that in the eye of a (human) observer the sub-frames (each of which have the spatial extent of the displayed image) are integrated together to create the desired image for display.

Each of the sub-frame holograms may itself be relatively noisy, for example as a result of quantising the holographic data into two (binary) or more phases, but temporal averaging amongst the sub-frames reduces the perceived level of noise. Embodiments of such a system can provide visually high quality displays even though each sub-frame, were it to be viewed separately, would appear relatively noisy.

A scheme such as this has the advantage of reduced computational requirements compared with schemes which attempt to accurately reproduce a displayed image using a single hologram, and also facilitate the use of a relatively inexpensive SLM.

Here it will be understood that the SLM will, in general, provide phase rather than amplitude modulation, for example a binary device providing relative phase shifts of zero and π(+1 and −1 for a normalised amplitude of unity). In preferred embodiments, however, more than two phase levels are employed, for example four phase modulation (zero, π/2, π, 3π/2), since with only binary modulation the hologram results in a pair of images one spatially inverted in respect to the other, losing half the available light, whereas with multi-level phase modulation where the number of phase levels is greater than two this second image can be removed. Further details can be found in our earlier application GB0329012.9 (ibid), hereby incorporated by reference in its entirety.

Although embodiments of the method are computationally less intensive than previous holographic display methods it is nonetheless generally desirable to provide a system with reduced cost and/or power consumption and/or increased performance. It is particularly desirable to provide improvements in systems for video use which generally have a requirement for processing data to display each of a succession of image flames within a limited frame period.

We have also described, in GB0511962.3, filed 14 Jun. 2005, a hardware accelerator for a holographic image display system, the image display system being configured to generate a displayed image using a plurality of holographically generated temporal sub-frames, said temporal sub-frames being displayed sequentially in time such that they are perceived as a single reduced-noise image, each said sub-frame being generated holographically by modulation of a spatial light modulator with holographic data such that replay of a hologram defined by said holographic data defines a said sub-frame, the hardware accelerator comprising: an input buffer to store image data defining said displayed image; an output buffer to store holographic data for a said sub-frame; at least one hardware data processing module coupled to said input data buffer and to said output data buffer to process said image data to generate said holographic data for a said sub-frame; and a controller coupled to said at least one hardware data processing module to control said at least one data processing module to provide holographic data for a plurality of said sub-frames corresponding to image data for a single said displayed image to said output data buffer.

In this preferably a plurality of the hardware data processing modules is included for processing data for a plurality of the sub-frames in parallel. In preferred embodiments the hardware data processing module comprises a phase modulator coupled to the input data buffer and having a phase modulation data input to modulate phases of pixels of the image in response to an input which preferably comprises at least partially random phase data. This data may be generated on the fly or provided from a non-volatile data store. The phase modulator preferably includes at least one multiplier to multiply pixel data from the input data buffer by input phase modulation data. In a simple embodiment the multiplier simply changes a sign of the input data.

An output of the phase modulator is provided to a space-frequency transformation module such as a Fourier transform or inverse Fourier transform module. In the context of the holographic sub-frame generation procedure described later these two operations are substantially equivalent, effectively differing only by a scale factor. In other embodiments other space-frequency transformation is may be employed (generally frequency referring to spatial frequency data derived from spatial position or pixel image data). In some preferred embodiments the space-frequency transformation module comprises a one-dimensional Fourier transformation module with feedback to perform a two-dimensional Fourier transform of the (spatial distribution of the) phase modulated image data to output holographic sub-frame data. This simplifies the hardware and enables processing of for example, first rows then columns (or vice versa).

In preferred embodiments the hardware also includes a quantiser coupled to the output of the transformation module to quantise the holographic sub-frame data to provide holographic data for a sub-frame for the output buffer. The quantiser may quantise into two, four or more (phase) levels. In preferred embodiments the quantiser is configured to quantise real and imaginary components of the holographic sub-frame data to generate a pair of sub-frames for the output buffer. Thus in general the output of the space-frequency transformation module comprises a plurality of data points over the complex plane and this may be thresholded (quantised) at a point on the real axis (say zero) to split the complex plane into two halves and hence generate a first set of binary quantised data, and then quantised at a point on the imaginary axis, say 0j, to divide the complex plane into a further two regions (complex component greater than 0, complex component less than 0). Since the greater the number of sub-frames the less the overall noise this provides further benefits.

Preferably one or both of the input and output buffers comprise dual-ported memory. In some particularly preferred embodiments the holographic image display system comprises a video image display system and the displayed image comprises a video frame.

Referring now to FIG. 1, this shows an example a consumer electronic device 10 incorporating a hardware projection module 12 to project a two-dimensional displayed image 14 on a screen. Displayed image 14 comprises a plurality of holographically generated sub-images each of the same spatial extent as displayed image 14, and displayed rapidly in succession so as to give the appearance of the displayed image. Each holographic sub-frame is generated along the lines described below. For further details reference may be made to GB 0329012.9 ((ibid).

In an embodiment, the various stages of the hardware accelerator implement the algorithm listed below. The algorithm is a method of generating, for each still or video frame I=I_{xy}, sets of N binary-phase holograms h^{(l)} . . . h^{(N)}. Statistical analysis of the algorithm has shown that such sets of holograms form replay fields that exhibit mutually independent additive noise.
1. Let G_{xy}⁽ⁿ⁾=1_{xy}exp (jφ_{xy}⁽ⁿ⁾) where φ_{xy}⁽ⁿ⁾ is uniformly distributed between 0 and 2π for 1≦n≦N/2 and 1≦x, y≦m
2. Let gᵤᵥ⁽ⁿ⁾=F⁻¹[(G_{xy}⁽ⁿ⁾] where F⁻¹ m represents the two-dimensional inverse Fourier transform operator for 1≦n≦N/2
3. Let mᵤᵥ⁽ⁿ⁾ [symbol] {gᵤᵥ⁽ⁿ⁾} for 1≦n≦N/2
4. mᵤᵥ^{n+n/2)}= [symbol] {gᵤᵥ⁽ⁿ⁾} for 1≦n≦N/2
5. Let

$${h}_{uv}^{( n )} = \{ \begin{matrix}- 1 & if {m}_{uv}^{( n )} < {Q}^{( n )} \\ 1 & if {m}_{uv}^{( n )} \geq {Q}^{( n )}\end{matrix}$$

where Q⁽ⁿ⁾=median (mᵤᵥ⁽ⁿ⁾) and 1≦n≦N

Step 1 folks N targets G_{xy}⁽ⁿ⁾ equal to the amplitude of the supplied intensity target I_{xy}, but with independent identically-distributed (i.i.t.), uniformly-random phase. Step 2 computes the N corresponding full complex Fourier transform holograms gᵤᵥ⁽ⁿ⁾. Steps 3 and 4 compute the real part and imaginary part of the holograms, respectively, Binarisation of each of the real and imaginary pails of the holograms is then performed in step 5: thresholding around the median of mᵤᵥ⁽ⁿ⁾ ensures equal numbers of −1 and 1 points are present in the holograms, achieving DC balance (by definition) and also minimal reconstruction error. In an embodiment, the median value of mᵤᵥ⁽ⁿ⁾ is assumed to be zero. This assumption can be shown to be valid and the effects of making this assumption are minimal with regard to perceived image quality. Further details can be found in the applicant's earlier application (ibid), to which reference may be made.

FIG. 2 shows an example optical system for the holographic projection module of FIG. 1.

Referring to FIG. 2, a laser diode 20 provides substantially collimated light 22 to a spatial light modulator 24 such as a pixellated liquid crystal modulator. The SLM 24 phase modulates lights 22 and the phase modulated light is provided a demagnifying optical system 26. In the illustrated embodiment, optical system 26 comprises a pair of lenses 28, 30 with respective focal lengths f₁, f₂, f₁<f₂, spaced apart at distance f₁+f₂.

Optical system 26 increases the size of the projected holographic image by diverging the light forming the displayed image, as shown.

Still referring to FIG. 2, in more detail lenses L₁ and L₂ (with focal lengths f₁ and f₂ respectively) from the beam-expansion pair or Keplerian telescope. This preferably expands the beam from the light source so that it covers substantially the whole surface of the modulator, apart from edge effects, so that the replay field is not significantly low-pass filtered.

Lens pair L₃ and L₄ (with focal lengths f₃ and f₄ respectively) form the beam-expansion pair. This effectively reduces the pixel size of the modulator, thus increasing the diffraction angle. As a result, the image size increases. The increase in image size (size of the replay field) is determined by the demagnification of the system and is set by the ratio of f₃ to f₄, which are the focal lengths of lenses L₃ and L₄ respectively.

Potentially a variable demagnification may be provided by using a variable focal length lens for L₃ and/or L₄ and adjusting the focal length to adjust the demagnification, for example reducing f₃ (and moving L₄ and/or increasing f₄ so that the focal points of L₃ and L₄ still coincide).

Two examples of such a lens are manufactured by Varioptic [M. Meister and R. J. Winfield, “Local improvement of the signal-to-noise ratio for diffractive optical elements designed by unidirectional optimization methods,” Applied Optics, vol. 41, 2002] and Philips [M. P. Chang and O. K. Ersoy, “Iterative interlacing error diffusion for synthesis of computer-generated holograms,” Applied Optics, vol. 32, 1993]. Both utilise the electrowetting phenomenon, in which a water drop is deposited on a metal substrate covered in a thin insulating layer. A voltage applied to the substrate modifies the contact angle of the liquid drop, thus changing the focal length. Other, less suitable, liquid lenses have also been proposed in which the focal length is controlled by the effect of a lever assembly on the lens aperture size [R. Eschbach, “Comparison of error diffusion methods for computer-generated holograms,” Applied Optics, vol. 30, 1991]. Solid-state variable focal length lenses, using the birefringence change of liquid crystal material under an applied electric field, have also been reported [R. Eschbach and Z. Fan, “Complex-valued error diffusion for off-axis computer-generated holograms,” Applied Optics, vol. 32, 1993, A. A. Falou, M. Elbouz, and H. Hamam, “Segmented phase-only filter binarized with a new error diffusion approach,” Journal of Optics A: Pure and Applied Optics, vol. 7, 2005, O. B. Frank Fetthauer, “On the error diffusion algorithm: object dependence of the quantization noise,” Optics Communications, vol. 120, 1995].

In a colour system light beams from red, green and blue lasers may be combined and modulated by a common SLM (time multiplexed). Techniques for implementing a colour display are described in more detail in UK patent application GB 0610784.1 filed on 2 Jun. 2006, also incorporated by reference in its entirety.

We have also described, in UK patent application GB 0606123.8 filed on 28 Mar. 2006, also incorporated by reference in its entirety, how one or more of the above lenses may be encoded onto the displayed hologram in order to provide a more compact optical system.

Continuing to refer to FIG. 2, a digital signal processor 100 has an input 102 to receive image data from the consumer electronic device defining the image to be displayed. The DSP 100 implements the procedure described above to generate phase hologram data for a plurality of holographic sub-frames which is provided from an output 104 of the DSP 100 to the SLM 24, optionally via a driver integrated circuit if needed. The DSP 100 drives SLM 24 to project a plurality of phase hologram sub-frames which combine to give the impression of displayed image 14. In one embodiment the holograms (holographic sub-frames) were displayed on an SXGA (1281×1024) reflective binary phase modulating spatial light modulator (SLM) made by CRL Opto (Forth Dimension Displays Limited, of Scotland, UK).

The DSP 100 may comprise dedicated hardware and/or Flash or other read-only memory storing processor control code to implement the above described procedure in order to venerate the sub-frame phase hologram data for output to the SLM 24.

FIG. 3 shows a block diagram of an embodiment of a hardware accelerator for the holographic image display system of the module 12 of FIG. 1. Further details may be found in PCT/GB2006/050152, filed 13 Jun. 2006, hereby incorporated by reference in its entirety.

Referring to FIG. 3, the input to the system is preferably image data from a source such as a computer (which may be embedded in a consumer or other device), although other data sources can also be employed. The input data is temporarily stored in one or more input buffer, with control signals for this process being supplied from one or more controller units within the system. Each input buffer preferably comprises dual-port memory such that data is written into the input buffer and read out from the input buffer simultaneously. The output from the input buffer shown in FIG. 1 is an image frame, labelled I, and this becomes the input to the hardware block. The hardware block, which is described in more detail using FIG. 2, performs a series of operations only each of the aforementioned image frames, I, and for each one produces one or more holographic sub-frames, h, which are sent to one or more output buffer. Each output buffer preferably comprises dual-port memory. Such sub-frames are outputted from the aforementioned output buffer and supplied to a display device, such as a SLM, optionally via a driver chip. The control signals by which this process is controlled are supplied from one or more controller unit. The control signals preferably ensure that one or more holographic sub-frames are produced and sent to the SLM per video frame period. In an embodiment, the control signals transmitted from the controller to both the input and output buffers are read/write select signals, whilst the signals between the controller and the hardware block comprise various timing, initialisation and flow-control information.

FIG. 4 shows an embodiment of a hardware block as described in FIG. 3, comprising a set of hardware elements designed to generate one or more holographic sub-frames for each image frame that is supplied to the block. In such an embodiment, preferably one image frame, I_{xy}, is supplied one or more times per video frame period as an input to the hardware block. The source of such image frames may be one or more input buffers as shown in FIG. 3. Each image frame, I_{xy}, is then used to produce one or more holographic sub-frames by means of a set of operations comprising one or more of: a phase modulation stage, a space-frequency transformation stage and a quantisation stage. In embodiments, a set of N sub-frames, where N is greater than or equal to one, is generated per frame period by means of using either one sequential set of the aforementioned operations, or a several sets of such operations acting in parallel on different sub-frames, or a mixture of these two approaches.

The purpose of the phase-modulation block shown in the embodiment of FIG. 4 is to redistribute the energy of the input frame in the spatial-frequency domain, such that improvements in final image quality are obtained after performing later operations.

FIG. 5 shows an example of how the energy of a sample image is distributed before and after a phase-modulation stage in which a random phase distribution is used. It can be seen that modulating an image by such a phase distribution has the effect of redistributing the energy more evenly throughout the spatial-frequency domain.

The quantisation hardware that is shown in the embodiment of FIG. 4 has the purpose of taking complex hologram data, which is produced as the output of the preceding space-frequency transform block, and mapping it to a restricted set of values, which correspond to actual phase modulation levels that can be achieved on a target SLM. In an embodiment, the number of quantisation levels is set at two, with an example of such a scheme being a phase modulator producing phase retardations of 0 or π at each pixel. In other embodiments, the number of quantisation levels, corresponding to different phase retardations, may be two or greater. There is no restriction on how the different phase retardations levels are distributed—either a regular distribution, irregular distribution or a mixture of the two may be used. In preferred embodiments the quantiser is configured to quantise real and imaginary components of the holographic sub-frame data to generate a pair of sub-frames for the output buffer, each with two phase-retardation levels. It can be shown that for discretely pixellated fields, the real and imaginary components of the complex holographic sub-frame data are uncorrelated, which is why it is valid to treat the real and imaginary components independently and produce two uncorrelated holographic sub-frames.

FIG. 6 shows an embodiment of the hardware block described in FIG. 3 in which a pair of quantisation elements are arranged in parallel in the system so as to generate a pair of holographic sub-frames from the real and imaginary components of the complex holographic sub-frame data respectively.

There are many different ways in which phase-modulation data, as shown in FIG. 4, may be produced. In an embodiment, pseudo-random binary-phase modulation data is generated by hardware comprising a shift register with feedback and an XOR logic gate. FIG. 7 shows such an embodiment, which also includes hardware to multiply incoming image data by the binary phase data. This hardware comprises means to produce two copies of the incoming data, one of which is multiplied by −1, followed by a multiplexer to select one of the two data copies. The control signal to the multiplexer in this embodiment is the pseudo-random binary-phase modulation data that is produced by the shift-register and associated circuitry, as described previously.

In another embodiment, pre-calculated phase modulation data is stored in a look-up table and a sequence of address values for the look-up table is produced, such that the phase-data read out from the look-up table is random. In this embodiment, it can be shown that a sufficient condition to ensure randomness is that the number of entries in the look-up table, N, is greater than the value, m, by which the address value increases each time, that m is not an integer factor of N, and that the address values ‘wrap around’ to the start of their range when N is exceeded. In a preferred embodiment, N is a power of 2, e.g. 256, such that address wrap around is obtained without any additional circuitry, and m is an odd number such that it is not a factor of N.

FIG. 8 shows suitable hardware for such an embodiment, comprising a three-input adder with feedback, which produces a sequence of address values for a look-up table containing a set of N data words, each comprising a real and imaginary component. Input image data, I_{xy}, is replicated to form two identical signals, which are multiplied by the real and imaginary components of the selected value from the look-up table. This operation thereby produces the real and imaginary components of the phase-modulated input image data, G_{xy}, respectively. In an embodiment, the third input to the adder, denoted n, is a value representing the current holographic sub-frame. In another embodiment, the third input, n, is omitted. In a further embodiment, m and N are both be chosen to be distinct members of the set of prime numbers, which is a strong condition guaranteeing that the sequence of address values is truly random.

FIG. 9 shows an embodiment of hardware which performs a 2-D FFT on incoming phase-modulated image data, G_{xy} as shown in FIG. 4. In this embodiment, the hardware required to perform the 2-D FFT operation comprises a 1-D FFT block, a memory element for storing intermediate row or column results, and a feedback path (which may incorporate a scaling factor) from the output of the memory to one input of a multiplexer. The other input of this multiplexer is the phase-modulated input image data, G_{xy}, and the control signal to the multiplexer is supplied from a controller block as shown in FIG. 4. Such an embodiment represents an area-efficient method of performing a 2-D FFT operation.

In other embodiments the operations illustrated in FIGS. 4 and/or 6 may be implemented partially or wholly in software, for example on a general purpose digital signal processor.

FIG. 10 shows a block diagram of further example hardware for a holographic image display system. The system incorporates hardware for a two-dimensional Fourier transform (realized by transforming the rows and the columns), a quantisation stage for both the real and the imaginary outputs of the Fourier transform (approximating a median quantiser by quantising around 0 or using a median value from a previous frame), a phase randomizer (using psedudo-random numbers generated from an XOR shift register), and (two) dual-memory frame buffers each comprising a pair of NtRAMs (No Turnaround Random Access Memory), one written to whilst the other is read.

In some implementations of an OSPR-type algorithm the input image is padded with zeros around the edges to create an enlarged image plane prior to performing a holographic transform, for example, so that the transformed image fits the SLM (for more details see co-pending UK patent application no. 0610784.1 filed 2 Jun. 2006, hereby incorporated by reference in its entirety. In such a case when performing an (I) FFT the zeros (more precisely, the zeroed areas) may be omitted to speed up the processing.

We refer to the example procedure described above as One Step Phase Retrieval (OSPR). However embodiments of the invention are also useful for OSPR-type procedures in which, strictly speaking, in some implementations it could be considered that more than one step is employed. Examples of these are described in GB05518912.1 filed 16 Sep. 2005 and GB0601481.5 filed on 25 Jan. 2006, both hereby incorporated by reference in their entirety. In the first of the above two patent applications “noise” in one sub-frame is compensated in a subsequent sub-frame so that the number of subframes required for a given image quality can be reduced. More particularly feedback is used so that the noise of each subframe compensates for the cumulative noise from previously displayed subframes. In the second, by calculating the holographic subframe data at a higher resolution than is used to display a subframe, phase-induced errors can be compensated by adjusting the target phase data for pixels of the image to compensate for the errors introduced. Preferably this is performed so that the desirable requirement of a substantially flat spatial spectrum is met.

Referring again to FIG. 2, in embodiments the reverse optical arrangement can be used for beam expansion prior to modulation, and for demagnification of the modulated light. Thus the lens pair L1 and L2 and the lens pair L3 and L4 may comprise at least part of a common optical system, used in reverse (in conjunction with a reflective SLM) for light incident on and reflected from the SLM.

FIG. 11a illustrates such a lens sharing arrangement, in which a polariser is included to suppress interference between light travelling in different directions, that is into and out of the SLM. FIG. 11b shows a preferred practical configuration of such a system, in which the laser diode (LD) does not obscure a central portion of the replay field. In the arrangement of FIG. 11b a polarising beam splitter is used to direct the output, modulated light at 90 degrees on the image plane, and also to provide the function of the polariser in FIG. 11a.

Applications for the above described holographic projection module include, but are not limited to, the following: mobile phone; PDA; laptop; digital camera; digital video camera; games console; in-car cinema; personal navigation systems (in-car or wristwatch GPS); head-up/helmet-mounted displays for automobiles or aviation; watch; personal media player (e.g. MP3 player, personal video player); dashboard mounted display; laser light show box; personal video projector (a “video iPod™”); advertising and signage systems; computer (including desktop); and a remote control unit. A projection module as described above may also be incorporated into an architectural fixture. In general embodiments of the above described holographic projection module are particularly useful in a device where it is desirable to share pictures or for more than one person to view an image at once.

No doubt many other effective alternatives will occur to the skilled person. It will be understood that the invention is not limited to the described embodiments and encompasses modifications apparent to those skilled in the art lying within the spirit and scope of the claims appended hereto.

1. A holographic projection module for a consumer electronic device, the holographic projection module comprising:
at least one substantially monochromatic light source;
a spatial light modulator (SLM) to phase modulate light from said light source to provide a phase hologram for generating a two-dimensional displayed image;
projection optics to project said phase modulated light to form said two-dimensional displayed image;
wherein said projection optics comprise an optical system configured to demagnify a conventional, non-holographic image, to increase the divergence of said light forming said displayed image; and
a digital signal processor to generate data for a plurality of temporal holographic subframes from a desired image for display, for modulating said SLM, such that temporal averaging amongst the subframes reduces the perceived level of noise, in said displayed image when images corresponding to the subframes are displayed successively and sufficiently fast that they are integrated together in the eye of a human observer.

2. A holographic projection module as claimed in claim 1 wherein each of said temporal subframes generates an image having substantially a spatial extent of said desired image for display.

3. A holographic projection module as claimed in claim 1 further comprising a collimator to collimate said light for said spatial light modulator.

4. A holographic projection module as claimed in claim 1 wherein said optical system comprises a first lens with a first focal length and a second lens with a second, shorter focal length, and wherein said first lens is closer to said SLM along an optical path from said SLM towards said displayed image than said second lens.

5. A holographic projection module as claimed in claim 4 wherein said first and second lenses are spaced apart along said optical path by a distance substantially equal to the sum of said first and second focal lengths.

6. A holographic projection module as claimed in claim 4 wherein said first and second lenses comprise positive lenses.

7. A holographic projection module as claimed in claim 1 wherein said optical system incorporates a filter to attenuate spatial regions of said displayed image.

8. A holographic projection module as claimed in claim 7 wherein said regions comprise one or more of an undiffracted spot and a repeated portion of said displayed image.

9. A holographic projection module as claimed in claim 7 wherein said filter comprises an aperture in said optical system.

10. A holographic projection module as claimed in claim 1 wherein said SLM comprises a reflective SLM.

11. A holographic projection module as claimed in claim 1 wherein said a digital signal processor is configured to input digital data for said desired image for display and to calculate from said image data holographic subframe data for driving said SLM to provide a said phase hologram, said digital signal processor being configured to implement a set of operations comprising a phase modulation stage, a space-frequency transformation stage, and a quantisation stage.

12. A holographic projection module as claimed in claim 11 wherein said digital signal processor comprises a processor and under the control of stored processor control code.

13. A holographic projection module as claimed in claim 11 wherein said digital signal processor includes a hardware accelerator.

14. A holographic projection module as claimed in claim 13 wherein said hardware accelerator includes hardware to implement one or more of said phase modulation, space-frequency transformation and quantisation stages.

15. A holographic projection module comprising:
at least one substantially monochromatic light source;
a spatial light modulator (SLM) to phase modulate light from said light source to provide a phase hologram for generating a displayed image; and
a digital signal processor configured to input digital data for said displayed image and to calculate hologram data for driving said SLM to provide said phase hologram for generating said displayed image; and
wherein said digital signal processor is configured to generate holographic data for a plurality of temporal sub-frames each approximating a hologram of an entire image to be displayed for driving said SLM to generate a plurality of phase hologram sub-frames such that, to a human observer, said temporal sub-frames give the impression of said displayed image, a noise variance of said displayed image being perceived as attenuated by averaging across said plurality of phase hologram subframes.

16. A holographic projection module comprising:
at least one substantially monochromatic light source;
a spatial light modulator (SLM) to phase modulate light from said light source to provide a phase hologram for generating a two-dimensional displayed image; and
projection optics to project said phase modulated light to form said two-dimensional displayed image;
wherein said SLM comprises a reflective SLM; and
wherein an optical path from said light source to said SLM includes at least a portion of said projection optics.

17. (canceled)

18. A holographic projection module as claimed in claim 16 wherein said optical path includes a polariser to suppress interference between light incident towards and light reflected from said SLM.

19. A holographic projection module as claimed in claim 18 wherein said polariser comprises a polarising beam splitter.

20. A holographic projection module as claimed in claim 16 wherein said projection optics comprise an optical system configured to demagnify a conventional, non-holographic image to increase the divergence of said light forming said displayed image.

21. A consumer electronic device including the holographic projection module of claim 16.

22. An advertising or signage system including the holographic projection module of claim 16.

23. A helmet mounded or head-up display including the holographic projection module of claim 16.
